(19) United States
(12) Patent Application Publication
(10) Pub. No.: US 2016/0092990 A1
(43) Pub. Date: Mar. 31, 2016

(54) GENERATING AND NAVIGATING INSURANCE PLAN COMPARISON INTERFACES

(71) Applicant: ADP, LLC, Roseland, NJ (US)

(72) Inventors: Benjamin J. Dziuba, New York, NY (US); Jesse S. Zolna, Larchmont, NY (US)

(21) Appl. No.: 14/497,425

(22) Filed: Sep. 26, 2014

(51) Int. Cl. G06Q 40/08; G06F 3/0484

(52) U.S. Cl. CPC G06Q 40/08; G06F 3/04847; G06F 3/04845; G06F 3/04842

(57) ABSTRACT

Methods and system for generating an employee benefit user interface (UI) are provided. A method includes generating a first level user interface (UI) based on a user input, wherein the first level UI simultaneously displays information of plural different insurance plans in respective areas associated with the plural different insurance plans; receiving a user input of a selected topic at an area of the first level UI outside the respective areas; and reconfiguring the first level UI to display, in the respective areas, information regarding the selected topic for each of the plural different insurance plans.

### TECHNICAL FIELD

The invention relates to user interfaces and, more particularly, to a method and system for generating and navigating a group of user interfaces for comparing insurance plans.

### BACKGROUND

Typically, an employer offers several medical insurance plans to their employees. These medical insurance plans come with different costs and different coverage. For example, one medical insurance plan can have a high deductible with a low premium; whereas, another medical insurance plan may have a low deductible with a high premium. These different plans can also include different co-payments and costs for different prescription drug plans. To complicate the selection process even more, the employer can offer certain benefits to their employees, ranging from health savings accounts (HSA) to premium support. With these many factors to consider, it becomes ever more difficult for a consumer to select an appropriate medical insurance plan.

Moreover, the decision making process for the employee is further complicated by the fact that the respective information about each plan is not located at a single, reviewable resource. Instead, information about each plan is often spread among different documents.

### SUMMARY OF INVENTION

In accordance with a first aspect of the invention, there is a method of generating an employee benefit user interface (UI). The method includes generating a first level user interface (UI) based on a user input, wherein the first level UI simultaneously displays information of plural different insurance plans in respective areas associated with the plural different insurance plans. The method further includes receiving a user input of a selected topic at an area of the first level UI outside the respective areas. The method additionally includes reconfiguring the first level UI to display, in the respective areas, information regarding the selected topic for each of the plural different insurance plans.

In accordance with another aspect of the invention, there is a computer system for generating an employee benefit user interface (UI). The computer system includes a hardware memory device that stores program instructions. The computer system also includes a hardware processor that executes the program instructions and causes the computer system to: receive an initial user input; generate a first level user interface (UI) based on the initial user input, wherein the first level UI simultaneously displays information of plural different insurance plans; determine a respective estimated cost for each of the plural different insurance plans based on a set of covered persons to be covered by the plural different insurance plans, wherein the displayed information includes the respective estimated costs; receive a user selection of a different set of covered persons; determine a new respective estimated cost for each of the plural different insurance plans based on the different set of covered persons; and reconfigure the first level UI to simultaneously display the new respective estimated costs.

In accordance with another aspect of the invention, there is a computer program product comprising computer readable program instructions stored on computer readable storage medium. The computer readable program instructions cause a computing device to: receive an initial user input; generate a first level user interface (UI) based on the initial user input, wherein the first level UI simultaneously displays information of plural different insurance plans; receive a user input to view details of a selected one of the plural different insurance plans; generate a second level UI that includes additional information associated with the selected one of the plans; navigate to the second level UI based on the receiving the user input to view details of the selected one of the plural different insurance plans; receive a user input to select a different one of the plural different insurance plans in the second level UI; and reconfigure the second level UI to display additional information associated with the different one of the plans while maintaining an arrangement of expanded and collapsed accordion areas of the second level UI.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 is an illustrative architecture of a computing system implemented as embodiments of the present invention;

FIG. 2 shows an exemplary cloud computing environment in accordance with aspects of the invention;

FIGS. 3-9 show user interfaces that illustrate functionality in accordance with aspects of the invention; and

FIG. 10 shows a block diagram in accordance with aspects of the invention; and

### DETAILED DESCRIPTION OF ASPECTS OF THE INVENTION

The invention relates to user interfaces and, more particularly, to a method and system for generating and navigating a group of user interfaces for comparing insurance plans. In accordance with aspects of the invention, a computer system generates a group of interrelated user interfaces that contain information about different insurance plans. The user interfaces are generated and provided to the user in a manner that permits the user to review and compare information about all the plans simultaneously at first level of data presentation, and to review more detailed information about each plan individually at a second level of data presentation. The UIs are configured such that a user may navigate directly (and with a single input) from a detailed view of a topic of one plan at the second level to a detailed view of the same topic of another plan at the second level, without having to return to the first level. The UIs are also configured such that the user may provide input via the interface to select who is covered by the plan, and instantly see an update to the user's estimated cost based on the selection. In this manner, implementations of the invention provide methods and systems for providing user interfaces that assist a user in selecting their desired insurance plan.

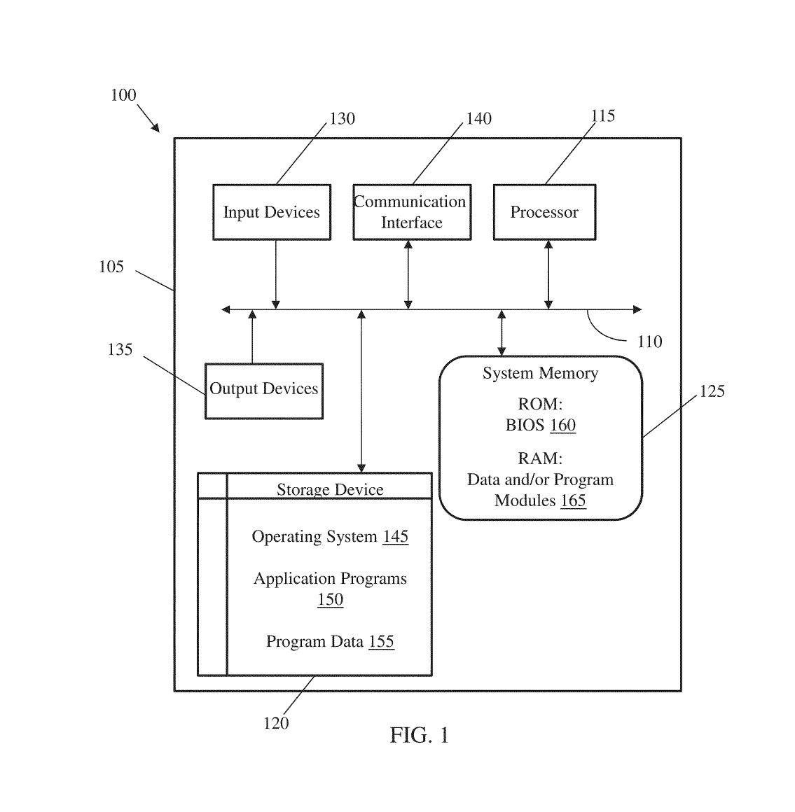

FIG. 1 is an illustrative architecture of a computing system 100 implemented as embodiments of the present invention. The computing system 100 is only one example of a suitable computing system and is not intended to suggest any limitation as to the scope of use or functionality of the invention. Also, computing system 100 should not be interpreted as having any dependency or requirement relating to any one or combination of components illustrated in computing system 100.

As shown in FIG. 1, computing system 100 includes a computing device 105. The computing device 105 can be resident on a network infrastructure such as within a cloud environment, or may be a separate independent computing device (e.g., a computing device of a third party service provider). The computing device 105 may include a bus 110, a processor 115, a storage device 120, a system memory 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more conventional processors or microprocessors that include any processing circuitry operative to interpret and execute computer readable program instructions, such as program instructions for controlling the operation and performance of one or more of the various other components of computing device 105. In embodiments, processor 115 interprets and executes the processes, steps, functions, and/or operations of the present invention, which may be operatively implemented by the computer readable program instructions. In embodiments, processor 115 may receive input signals from one or more input devices 130 and/or drive output signals through one or more output devices 135. The input devices 130 may be, for example, a keyboard or touch sensitive user interface (UI) as further described below. The output devices 135 can be, for example, any display device, printer, etc., as further described below.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present invention In embodiments, storage device 120 may store operating system 145, application programs 150, and program data 155 in accordance with aspects of the present invention.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The one or more input devices 130 may include one or more mechanisms that permit an operator to input information to computing device 105, such as, but not limited to, a touch pad, dial, click wheel, scroll wheel, touch screen, one or more buttons (e.g., a keyboard), mouse, game controller, track ball, microphone, camera, proximity sensor, light detector, motion sensors, biometric sensor, and combinations thereof. The one or more output devices 135 may include one or more mechanisms that output information to an operator, such as, but not limited to, audio speakers, headphones, audio line-outs, visual displays, antennas, infrared ports, tactile feedback, printers, or combinations thereof.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured to generate and navigate user interfaces and related functionality as described herein. In particular, computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In some embodiments, an operator may interact with computing device 105 via the one or more input devices 130 and/or the one or more output devices 135 to facilitate performance of the tasks and/or realize the end results of such tasks in accordance with aspects of the present invention. In additional or alternative embodiments, hardwired circuitry may be used in place of or in combination with the program instructions to implement the tasks, e.g., steps, methods and/or functionality, consistent with the different aspects of the present invention. Thus, the steps, methods and/or functionality disclosed herein can be implemented in any combination of hardware circuitry and software.

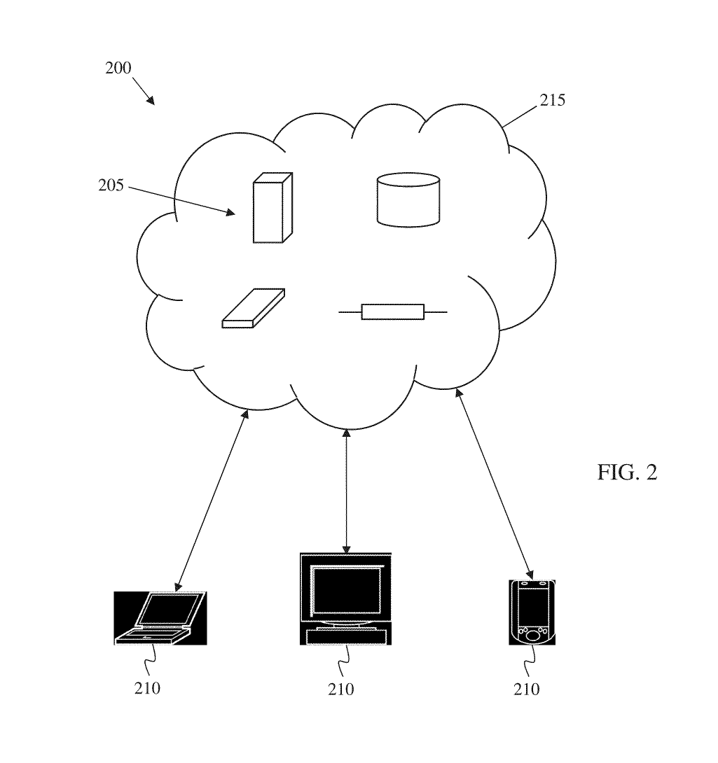

FIG. 2 shows an exemplary cloud computing environment 200. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. Client devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210. In embodiments, cloud resources 205 may includes one or more computing system 100 of FIG. 1 that is specifically adapted to perform one or more of the functions and/or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

One or more cloud resources 205 may be conceptually structured in multiple layers. In one example, the layers include a firmware and hardware layer, a kernel layer, an infrastructure service layer, a platform service layer, and an application service layer. The firmware and hardware layer may be the lowest layer upon which the other layers are built, and may include generic contributing nodes (e.g., data centers, computers, and storage devices) geographically distributed across the Internet and provide the physical resources for implementing the upper layers of the cloud service provider. The kernel layer is above the firmware and hardware layer and may include an operating system and/or virtual machine manager that host the cloud infrastructure services. The kernel layer controls and communicates with the underlying firmware and hardware layer through one or more hardware/firmware-level application programming interfaces (APIs). The infrastructure service layer is above the kernel layer and may include virtualized resources, such as virtual machines, virtual storage (e.g., virtual disks), virtual network appliances (e.g., firewalls), and so on. The infrastructure service layer may also include virtualized services, such as database services, networking services, file system services, web hosting services, load balancing services, message queue services, map services, e-mail services, and so on. The platform service layer is above the infrastructure service layer and may include platforms and application frameworks that provide platform services, such as an environment for running virtual machines or a framework for developing and launching a particular type of software application. The application service layer is above the platform service layer and may include a software application installed on one or more virtual machines or deployed in an application framework in the platform service layer. The software application can also communicate with one or more infrastructure service components (e.g., firewalls, databases, web servers, etc.) in the infrastructure service layer.

In another example, one or more cloud resources 205 may be conceptually structured in functional abstraction layers including a hardware and software layer, a virtualization layer, a management layer, and a workloads layer. The hardware and software layer may include hardware and software components such as mainframes, RISC (reduced instruction set computer) architecture based servers, storage devices, networks and networking components, application server software, and database software. The virtualization layer may include virtual entities such as virtual servers, virtual storage, virtual networks, virtual applications, and virtual clients. The management layer may provide functions such as resource provisioning, metering and pricing, security, user portals, service level management, and service level agreement planning and fulfillment. The workloads layer may provide functions for which the cloud computing environment is utilized, such as mapping and navigation, software development and lifecycle management, data analytics and processing, and transaction processing.

In embodiments, software and/or hardware that performs one or more of the aspects, functions and/or processes described herein may be accessed and/or utilized by a client (e.g., an enterprise or an end user) as one or more of an SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

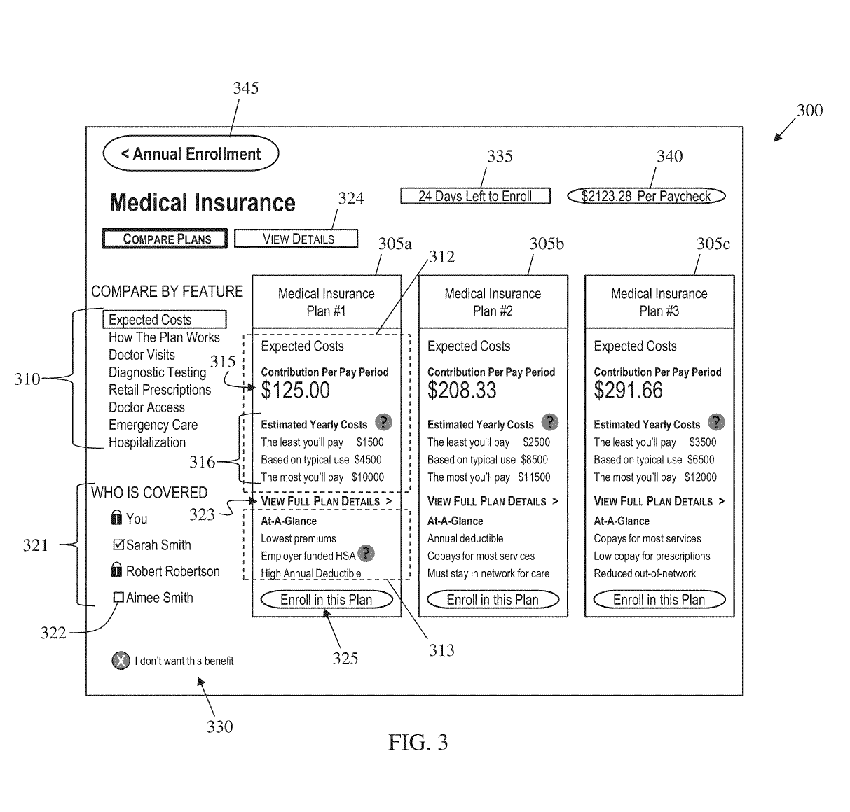

FIGS. 3-9 show various user interfaces (UIs) representative and illustrative of functionality in accordance with aspects of the present invention. The UIs can be provided on a user computer device (e.g., client device 210 of FIG. 2) via a network (e.g., network 215). In addition, the underlying functionality shown in the UIs can be provided by a back-end system, such as the computing system 100 of FIG. 1. For example, data that defines each screen of the UIs may be generated and/or provided to the user computer device at least in part by the computing system 100. The data may be obtained by the computing system 100 from disparate sources, such as for example a human resources database and a payroll database.

In embodiments, the various UIs described with respect to FIGS. 3-9 may be part of a collection of interfaces that make up an overall employee benefit UI that is generated at least in part by a service provider computing device such as computing system 100 of FIG. 1. Generating the UIs may include: accessing stored information associated with each one of the plural different insurance plans, and formatting the accessed information for display in predefined areas of the UIs. The particulars of the UIs shown in FIGS. 3-9 are exemplary and shown for the purpose of illustrating processes and functionality of aspects of the invention, and are not intended to limit the invention.

In some instances, the UIs of FIGS. 3-9 include selectable objects that are adapted for prompting and defining input from a user. As used herein, the term “selectable object” refers to a button or hyperlink or similar object that is displayed in a UI, that may be selected by the user with a user input such as a mouse click or finger tap, and that when selected by the user results in a change in the UI. It should be understood by those of skill in the art that the nomenclature used for any of the buttons, icons or descriptive terms herein is provided as an illustrative example, and that other descriptive terms, icons, and/or scroll down windows are contemplated by the present invention.

Specifically, FIG. 3 shows a plan comparison user interface (UI) 300. In accordance with aspects of the invention, the comparison UI 300 corresponds to a first level UI that simultaneously displays information for plural different insurance plans. Specifically, as shown in FIG. 3, the comparison UI 300 includes respective areas 305a-c that display information of each respective plan. For example, area 305a displays information associated with plan #1, area 305b displays information associated with plan #2, and area 305c displays information associated with plan #3. In embodiments, each of these plans can be a medical insurance plan offered by an employer to an employee by way of an example. It should be understood by those of skill in the art that although three plans are shown in UI 300, any number of plans and associated costs, depending on factors such as employer approved plans, etc., are contemplated by the present invention.

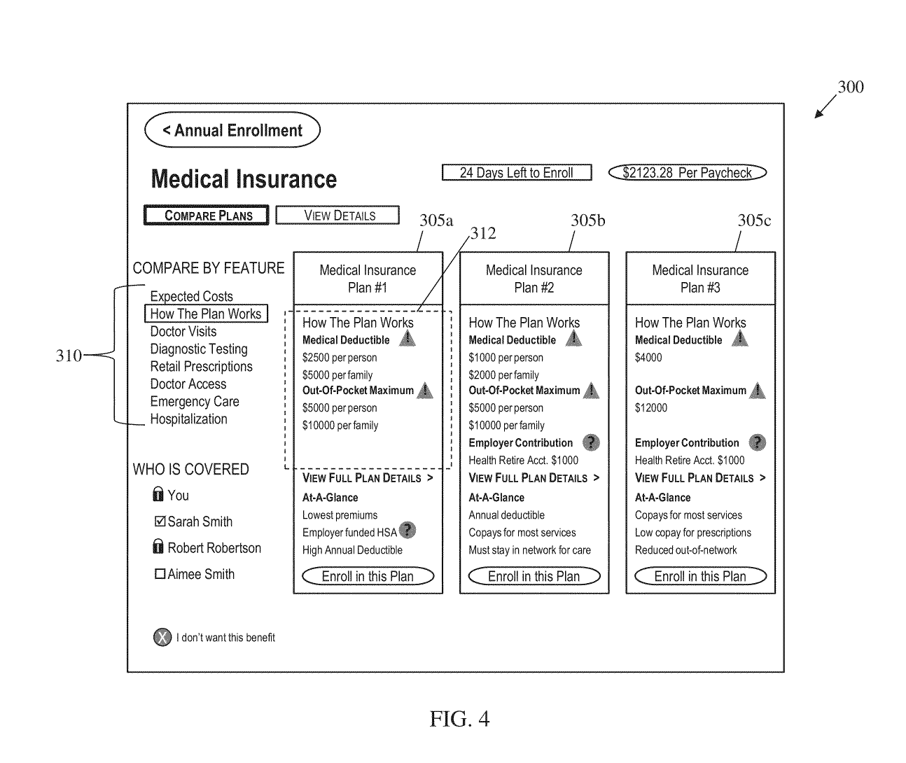

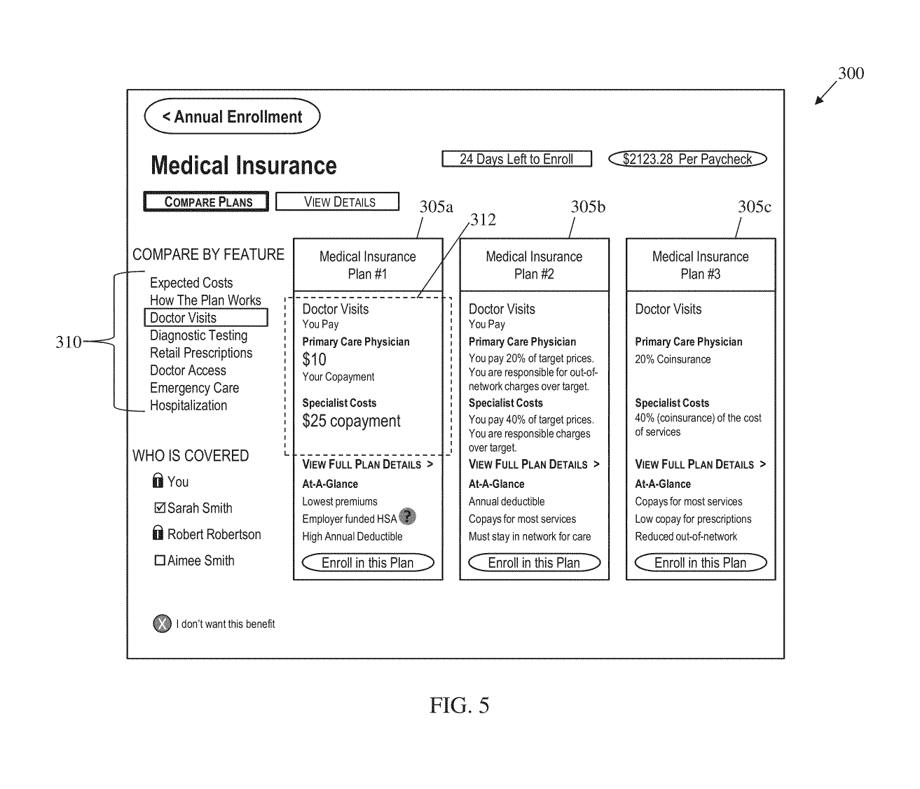

As shown further in FIG. 3, the comparison UI 300 includes a list 310 of topics (e.g., features) that are individually selectable by the user and that define what information is presented in the areas 305a-c. For example, in FIG. 3 the user has selected the topic “Expected Costs” (as indicated by the highlighted appearance of the text), which causes the system to generate the comparison UI 300 such that area 305a displays information regarding the expected costs of plan #1, area 305b displays information regarding the expected costs of plan #2, and area 305b displays information regarding the expected costs of plan #3. By selecting a different one of the topics in the list 310, the user may cause the system to change what information is displayed in each of the areas 305a-c, as described in greater detail herein with respect to FIGS. 4 and 5. For example, starting at the comparison UI 300 as shown in FIG. 3, the user may select the topic “How the Plan Works” in the list 310 to cause the comparison UI 300 to change from that shown in FIG. 3 to that shown in FIG. 4. It should be understood by those of skill in the art that although particular topics are shown in the list 300 (i.e., Expected Costs, How The Plan Works, Doctor Visits, Diagnostic Testing, Retail Prescriptions, Doctor Access, Emergency Care, and Hospitalization), any number and types of topics may be used.

In embodiments, each of the areas 305a-c includes a dynamic area indicated by dashed line box 312 that is changeable based on user input, and a static area indicated by dashed line 313. For example, the information that is associated with the selected topic from the list 310 is displayed in the dynamic area 312, such that the information displayed in the dynamic area 312 changes based on user input. Specifically, in the example shown in FIG. 3, the user has selected “Expected Costs” in the list 310, which causes the system to generate the comparison UI 300 such that the dynamic area 312 of each of the areas 305a-c displays expected costs information for each of the respective plans. On the other hand, information in the static area 313 remains the same regardless of which topic of the list 310 is selected by the user. In the example shown in FIG. 3, the static area 313 is populated with “At-A-Glance” information for each respective plan, although any desired information may be displayed in the static area 313. In embodiments, the “At-A-Glance” information can include different bullet points of information about each of the plans based on such factors as, e.g., lowest premiums, employee funded health savings accounts (HSA), no cost preventative care, high annual deductibles, etc.

As shown further in FIG. 3, for each of the different plans at areas 305a-c, an expected contribution per pay period is shown at reference numeral 315. The expected contribution per pay period 315 is based on a total yearly cost of the medical insurance divided by the number of paychecks the consumer may receive in any given year. The total yearly cost of each insurance plan is represented by the “least you'll pay” line item shown in reference numeral 316. So, for the example of medical plan #1, an employee receiving 12 paychecks per year would have an estimated contribution per pay period 315 in the amount of $125, based on a least amount paid of $1,500 as shown at reference numeral 316. Of course, it should be understood by those of skill in the art that the contribution per paycheck can vary depending on the number of paychecks per year, the typical usage, as well as other factors such as individual usage scenarios and benefits received from the employer. For example, if the employee receives benefits in the amount of $500 per year from an employee, an appropriate adjustment will be made to both the least amount paid and the contribution per pay check. In embodiments, the system determines the expected costs for each plan based on predefined data for each plan. For example, the baseline yearly cost for different levels of coverage of each plan (e.g., self, self and spouse, self and child, family, etc.) may be stored and accessed and used by the system to determine expected costs that are displayed in areas 315 and 316. Additional demographic data may be stored and used to determine “typical use” cost estimates for each plan.

Still referring to FIG. 3, the comparison UI 300 also includes a total estimated yearly cost of the medical plan. In embodiments, the estimated yearly cost is based different factors, including demographic information. These different costs can be, e.g., least amount of usage, typical amount usage and most amount of usage, shown generally at reference numeral 316. The typical amount of usage can be adjusted based on user provided information which, in turn, will automatically update the expected cost for contribution per pay period at reference numeral 315.

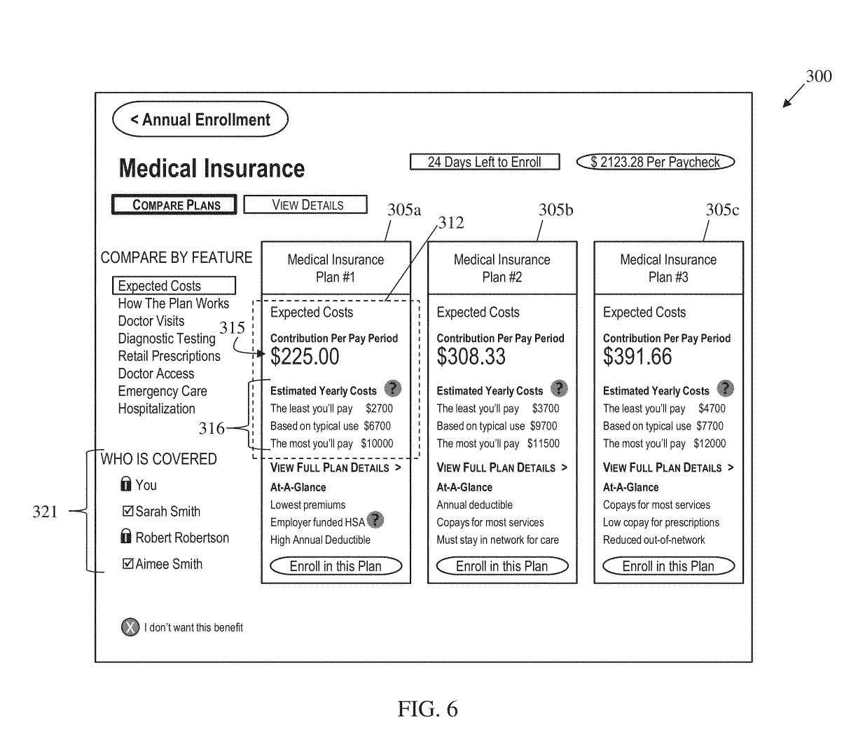

To assist the user in comparing costs of each plan, the comparison UI 300 may include a “who is covered” area 321 in which the user may select which persons are covered by the plan. In accordance with aspects of the invention, the estimated contribution per pay period 315 and estimated costs 316 are determined based on which persons are selected in the area 321. For example, adding coverage for a spouse and/or child may change the plan from a single plan to a self-and-spouse plan or a family plan, which changes the baseline yearly cost of the medical insurance. Accordingly, when the user selects or de-selects a name in the “who is covered” area 321, the system recalculates the costs for each plan (based on the selected persons at area 321) and changes the display of the estimated contribution per pay period 315 and estimated costs 316 in each of the areas 305a-c. This is demonstrated in FIG. 6, in which the user has selected “Aimee Smith” in the “who is covered” area 321, which results in the estimated contribution per pay period 315 and estimated costs 316 of FIG. 6 being different than the values shown in FIG. 3. In this manner, the user may perform “what if” scenarios by adding and/or subtracting persons from coverage to see how it affects the costs of each plan. This provides a technological advantage of permitting the user to simultaneously view expected costs of plural different plans on a single screen, and permitting the user provide a change to who is covered that causes a recalculation and redisplay of the expected costs of each of the different plans on the same screen.

Still referring to the “who is covered” area 321 of the comparison UI 300 of FIG. 3, in embodiments the system populates the names in the area 321 using data that the user has previously provided at another interface. For example, prior to arriving at the comparison UI 300, the system may prompt the user to enter information about dependents, such as name, age, relationship, etc. Subsequently, when generating the comparison UI 300, the system includes these user-provided names at area 321 and provides a selectable object 322 next to each name. In embodiments, the system uses the relationship data previously input by the user for each dependent when calculating the expected costs. For example, based on the user designating Sarah Smith as a spouse, the system determines the expected costs for self-and-spouse coverage of each plan when the user selects only Sarah Smith in the area 321. As another example, based on the user designating Sarah Smith as a spouse and Aimee Smith as a child, the system determines the expected costs for family coverage of each plan when the user selects both Sarah Smith and Aimee Smith in the area 321.

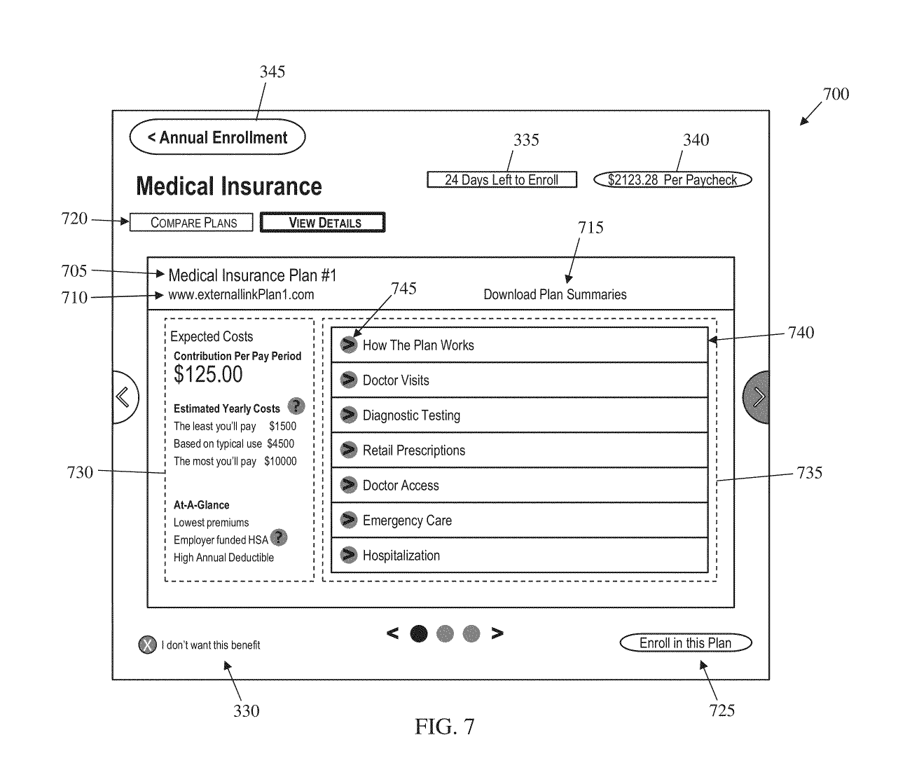

With continued reference to FIG. 3, each of the areas 305a-c may include a “view full plan details” selectable object 323 that the user may select to view more details of the particular plan. In embodiments, when the user selects the selectable object 323 in a particular one of the areas 305a-c, the system navigates the user to a “details” UI that displays more information about the selected plan. For example, selecting the selectable object 323 navigates the user to plan #2 in the details UI. The details UI is described herein with reference to FIGS. 7-9.

The comparison UI 300 may also include a “view details” selectable object 324 that the user may select to navigate to the details UI to view more details of the plans. In embodiments, when the user selects the view details selectable object 324, the system navigates the user to the details UI similar to that described above with respect to selectable object 323 and as described herein with reference to FIGS. 7-9. Selecting the view details selectable object 324 navigates the user to the details UI using a default plan (e.g., the first plan) as the starting point at the details UI. This is in contrast to selecting the selectable object 323 in one of the areas 305a-c, which navigates the user to the details UI using the particular selected plan as the starting point at the details UI (i.e., selecting the selectable object 323 in area 305c takes the user to the details UI with plan #3 as the starting pint at the details UI). In this manner, the comparison UI 300 simultaneously provides two different links to navigate to the details UI: a first link to navigate directly to a particular plan in the details UI by selecting the selectable object 323 in a particular area 305a-c; and a second link to navigate to a default view of the details UI by selecting the selectable object 324.

To assist in the enrollment process each of the areas 305a-c may include an “Enroll in this Plan” selectable object 325 that the user may select to enroll in the particular plan. In embodiments, when the user selects the selectable object 325 in one of the areas 305a-c, the system navigates the user to a confirmation screen that displays the name of the selected plan and prompts the user to positively confirm (e.g., with an additional input) their selection of this particular plan. For example, the user selecting the selectable object 325 in area 305c causes the system to navigate the user to a confirmation screen for confirming their selection of plan #3.

Still referring to FIG. 3, the comparison UI 300 may also include an “I don't want this benefit” selectable object 330 that the user may select to indicate voluntary waiver of this benefit. In the example of medical insurance, the user may already be covered by another person's plan, and thus may wish to waive their own purchase of medical insurance. In embodiments, when the user selects the selectable object 330, the system navigates the user to a confirmation screen that prompts the user to positively confirm (e.g., with an additional input) their election to waive this benefit.

The comparison UI 300 also provides additional information about the particular medical plans including, for example, a “days left to enroll” selectable object 335. The days left to enroll can be based on an open enrollment period and, more specifically, the number of days left in an open enrollment period. By selecting the days left to enroll selectable object 335, a calendar with the last day of open enrollment for a particular medical plan can be displayed to the user, as an example.

The comparison UI 300 as shown in FIG. 3 may also include a total cost 340 of all benefits. In embodiments, the total cost 340 is a cost to the user of all selected benefits, including benefits that are not shown in UI 300. For example, UI 300 may be part of a larger benefit election UI in which the user may elect various benefits such as: medical insurance (as described herein), vision insurance, dental insurance, life insurance, accidental death and dismemberment insurance, disability insurance, spousal insurance, dependent care, commuter benefit, educational assistance, retirement benefits, etc. There may be costs associated with one or more of the benefits, and the total cost 340 represents a cumulative total cost of all the elections made by the user across all benefits.

The comparison UI 300 as shown in FIG. 3 may also include an “annual enrollment” selectable object 345, which the user may select to navigate out of the comparison UI 300. As described herein, the comparison UI 300 may be part of a larger benefit election UI. In embodiments, selecting the annual enrollment selectable object 345 navigates the user to a higher-level annual enrollment UI at which the user may choose to visit other benefit UIs, such as UIs related to vision insurance, dental insurance, life insurance, accidental death and dismemberment insurance, etc.

FIG. 4 shows the comparison UI 300 after the user has selected the topic “How The Plan Works” in the list 310. As described with respect to FIG. 3, selecting a different topic in the list 310 causes the system to change what information is displayed in each of the areas 305a-c. For example, selecting the “How The Plan Works” topic causes the system to generate the comparison UI 300 such that the dynamic are 312 of each of the areas 305a-c displays information regarding, for example, deductibles, out of pocket maximums, etc. Specifically, in this example, area 305a displays information regarding the deductible and out of pocket maximums for plan #1, area 305b displays this information for plan #2, and area 305c displays this information for plan #3. The particular information that is displayed in each area 305a-c may be stored in a database and retrieved by the computer system when the user selects one of the topics in the list 310.

FIG. 5 shows the comparison UI 300 after the user has selected the topic “Doctor Visits” in the list 310. In this example, this input by the user causes the system to generate the comparison UI 300 such that the dynamic are 312 of each of the areas 305a-c displays information regarding, for example, copay information, coinsurance information, etc.

Thus, by selecting one of the topics of the list 310, the user may cause the comparison UI 300 to change the type of information that is displayed in each of the areas 305a-c. This provides the technological advantage of permitting the user to view and compare topics (i.e., features) of the different plans simultaneously on a single screen, combined with permitting the user to switch from a first topic to a second topic with a single input, e.g., a mouse click or finger tap on one of the topics of the list 310.

FIG. 6 shows the comparison UI 300 after the user selected another name in the “who is covered” area 321. Specifically, in the UI 300 of FIG. 6 the user selected “Aimee Smith” and “Sarah Smith” in the area 321, which represents a different group of people to be covered compared to the UI 300 of FIG. 3 where the user selected “Sarah Smith” but did not select (or de-selected) “Aimee Smith”. Accordingly, the expected costs 315 and 316 displayed in areas 305a-c are different in FIG. 6 than in FIG. 3, based on a different group of people being covered.

FIG. 7 shows a “view details” user interface (UI) 700. In accordance with aspects of the invention, the details UI 700 corresponds to a second level UI that displays additional information about one of the plans from the UI 300 of FIG. 3. In the example depicted in FIG. 7, the details UI 700 displays detailed information associated with plan #1, which corresponds to area 305a of the UI 300 of FIG. 3. For example, the user may navigate to the details UI 700 shown in FIG. 7 by selecting the “view full plan details” 323 selectable object in area 305a of FIG. 3.

In embodiments, the detail UI 700 includes the plan name 705, a hyperlink to a website 710 of the insurer that provides the plan, a selectable object 715 for downloading documentation associated with the plan, and a “compare plans” selectable object 720 that navigates back to the comparison UI 300. The detail UI 700 may also include the “I don't want this benefit” selectable object 330, the “days left to enroll” selectable object 335, the total cost 340, and the “annual enrollment” selectable object 345 that function in the same manner as described with respect to FIG. 3. The detail UI 700 may also include an “enroll in this plan” selectable object 725 that functions in a similar manner as the “enroll in this plan” selectable object 325 described with respect to FIG. 3.

Still referring to FIG. 7, the detail UI 700 may be configured to have a static area 730 and a dynamic area 735 for displaying particular information associated with the selected plan. In embodiments, the static area 730 includes the “Expected Costs” and “At-A-Glance” information associated with the selected plan, while the dynamic area 735 includes collapsible accordion areas 740 that correspond to one or more of the topics included in the list 310 of FIG. 3. Each accordion area 740 has a selectable object 745 that the user may select to expand and collapse the accordion area 740.

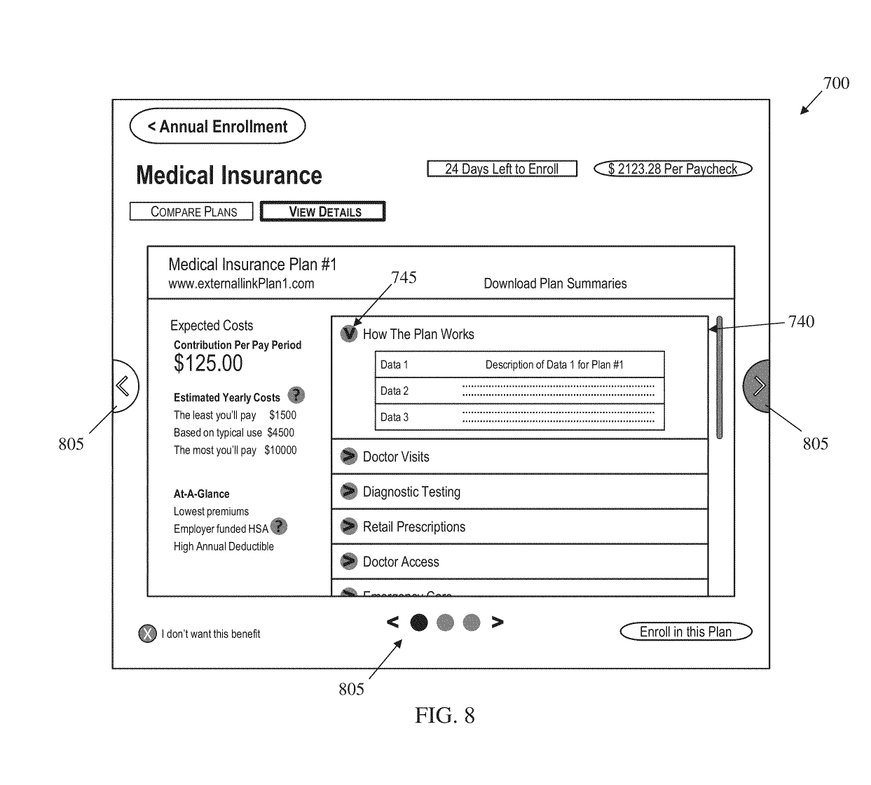

FIG. 8 shows the detail UI 700 displaying information for plan #1 with the “How The Plan Works” accordion area 740 expanded, as a result of the user selecting the selectable object 745 in the “How The Plan Works” accordion area 740 of FIG. 7. The expanded “How The Plan Works” accordion area 740 as shown in FIG. 8 shows detailed information about the topic, which may include more information about the topic than is viewable in the comparison UI 300. For example, the UI 300 of FIG. 3 displays concise, summary information for a topic in the list 310, whereas the detail UI 700 of FIG. 7 shows additional information on the same topic that provides a more detailed explanation when compared to the concise, summary information of UI 300. The additional information displayed in the expanded accordion area 740 may be stored in memory and accessed by the computer system based on the user selecting the selectable object 345. The user may select any of the selectable objects 745 in any of the accordion areas 740 to expand the selected accordion area 740 to view the detailed information about a particular topic.

As depicted in FIG. 8, the detail UI 700 includes one or more navigation objects 805 for moving between the plans while remaining at the level of the detail UI 700. For example, while viewing the details of plan #1 in the detail UI 700 as shown in FIG. 8, the user may select a navigation object 805 to change the detail UI 700 to show details for plan #2.

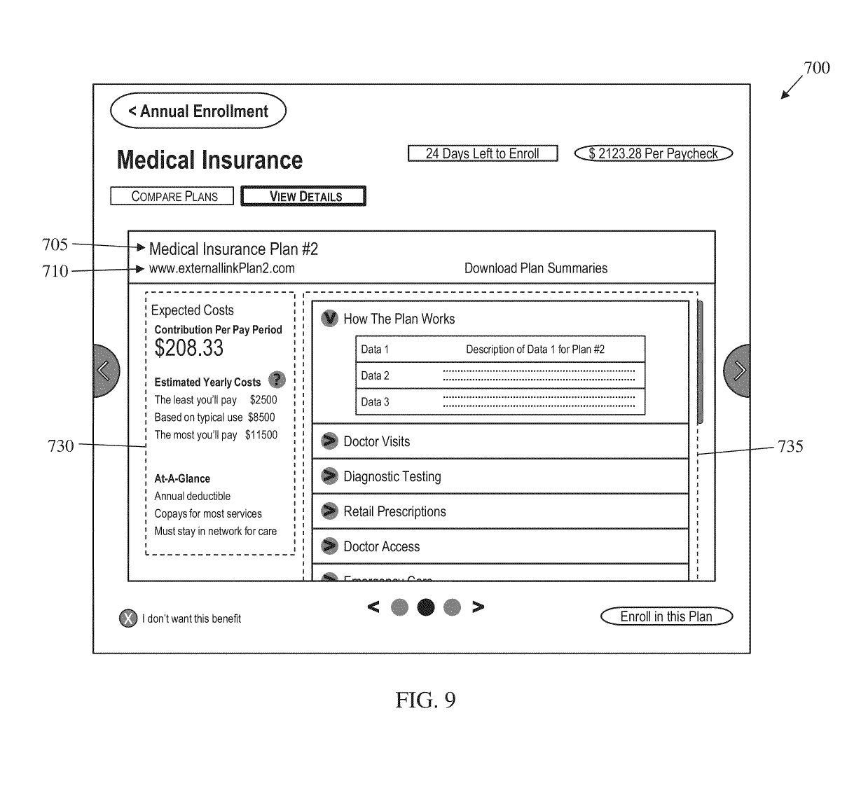

FIG. 9 shows the detail UI 700 displaying information for plan #2 as a result, for example, of the user selecting one of the navigation objects 805 of the detail UI 700 of FIG. 8. As depicted in the detail UI 700 shown in FIG. 9, the plan name 705, the hyperlink to the website 710, the “Expected Costs” and “At-A-Glance” information in the static area 730, and the additional information in the dynamic area 735 all correspond to the information of plan #2, as opposed to plan #1 as shown in FIGS. 7 and 8.

In accordance with aspects of the invention, the detail UI 700 retains the same arrangement of expanded and collapsed accordion areas 740 when navigating from one plan to another. For example, FIG. 8 shows the detail UI 700 displaying information for plan #1 with the “How The Plan Works” accordion area 740 expanded and the remaining accordion areas 740 collapsed. FIG. 9 shows the detail UI 700 as a result of the user selecting one of the navigation objects 805 of the detail UI 700 of FIG. 8. Specifically, FIG. 9 shows the detail UI 700 displaying information for plan #2, and having the same accordion area arrangement as was previously displayed to the user when viewing plan #1, i.e., with the “How The Plan Works” accordion area 740 expanded and the remaining accordion areas 740 collapsed. This provides a technological advantage of permitting the user to drill down to a selected topic for a selected plan, and permitting the user provide a single input to view the same topic at the same level of granularity for a different plan.

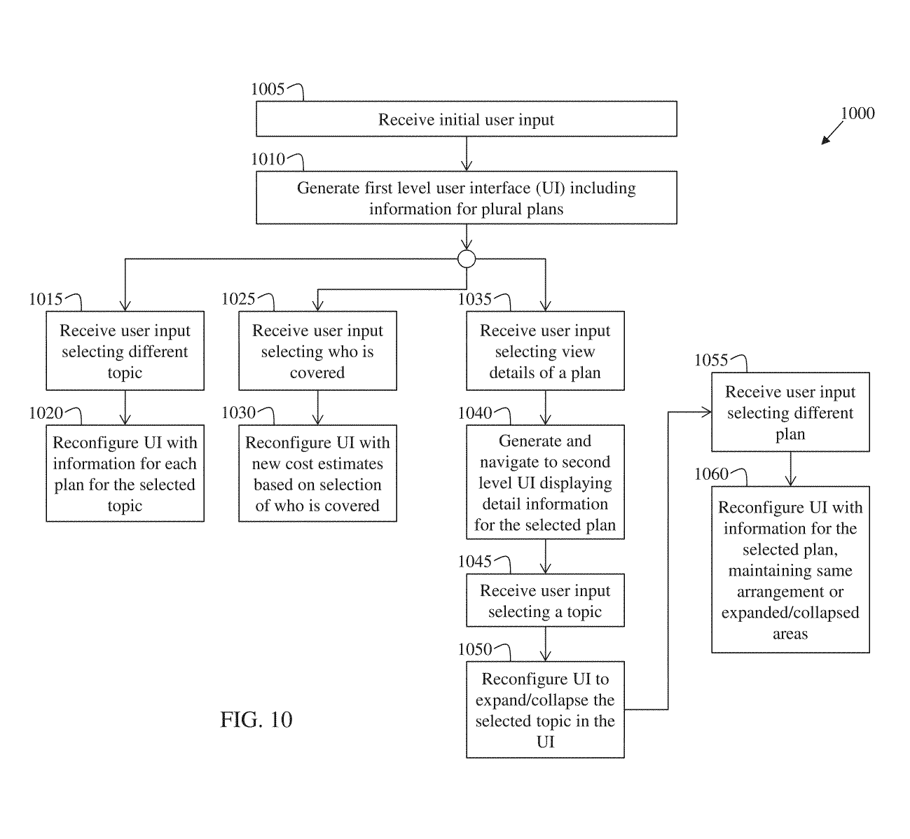

FIG. 10 depicts an exemplary flow for a process in accordance with aspects of the present invention. The exemplary flow can be illustrative of a system, a method, and/or a computer program product and related functionality implemented on the computing system of FIG. 1, in accordance with aspects of the present invention. The computer program product may include computer readable program instructions stored on computer readable storage medium (or media). The computer readable storage medium include the one or more storage medium as described with regard to FIG. 1, e.g., non-transitory media, a tangible device, etc. The method, and/or computer program product implementing the flow of FIG. 10 can be downloaded to respective computing/processing devices, e.g., computing system of FIG. 1 as already described herein, or implemented on a cloud infrastructure as described with regard to FIG. 2. Accordingly, the processes associated with each flow of the present invention can be implemented by special purpose hardware-based systems that perform the specified functions or acts or carry out combinations of special purpose hardware and computer instructions.

Referring to FIG. 10, at step 1000, a computer system (e.g., computer system 100 of FIG. 1) receives an initial user input from a user computer device (e.g., client device 210 of FIG. 2). The initial user input may include, for example, a selection by the user to navigate to a compare plans user interface. The initial user input may additionally or alternatively include user-provided information regarding dependents (e.g., name, age, relationship, etc.).

At step 1010, the computer system generates a first level user interface (UI) that includes information for plural different insurance plans. In embodiments, the first level UI is a compare UI 300 as described with respect to FIG. 3. The compare UI 300 may include, based on the user input from step 1005, names of persons who are selectable/de-selectable to be covered under the insurance, e.g., as in area 321. In embodiments, the compare UI 300 simultaneously displays information about each of the plural different insurance plans, e.g., so that the user may compare different topics of the different plans on a single screen. In embodiments, the compare UI 300 includes a list of topics 310 that are selectable by the user for displaying information of each plan about each topic.

At step 1015, the computer system receives a user input to select a different topic, e.g., from the list 310. At step 1020, the computer system reconfigures the compare UI 300 based on the topic selected at step 1015. Specifically, the computer system changes the information displayed in areas associated with the respective plans to display information related to the selected topic. Steps 1015 and 1020 may be performed in the manner described with respect to FIGS. 4 and 5, for example.

At step 1025, the computer system receives a user input to select who is covered, e.g., from the area 321 of the compare UI 300. At step 1030, the computer system reconfigures the compare UI 300 based on the persons selected at step 1025. Specifically, the computer system changes the estimated costs displayed at areas 315 and 316 of the UI 300. Steps 1025 and 1030 may be performed in the manner described with respect to FIG. 6, for example.

At step 1035, the computer system receives a user input to select a view details interface for a particular plan. For example, the user may select the selectable object 325 in one of the areas 305a-c of the UI 300. At step 1040, based on the user input at step 1035, the computer system generates a second level UI and navigates the user to the second level UI. In embodiments, the second level UI is a detail UI 700 as described with respect to FIG. 7. In embodiments, the details UI 700 displays information for a single one of the plans corresponding to the plan that was selected at step 1035.

At step 1045, the computer system receives a user input to select a topic. For example, the user may select a selectable object 745 in a particular accordion area 740 in the detail UI 700. At step 1050, the computer system reconfigures the detail UI 700 to expand or collapse the accordion area 740 associated with the selectable object 745 that was selected at step 1045. Steps 1045 and 1050 may be performed in the manner described with respect to FIG. 8, for example.

At step 1055, the computer system receives a user input to select a different plan. For example, the user may select a selectable navigation object 805 in the detail UI 700 to change plans within the detail UI 700. At step 1060, the computer system reconfigures the detail UI 700 to display information for the selected plan. In embodiments, when navigating from one plan to another plan within the detail UI 700, the computer system operates to maintain a same arrangement of expanded/collapsed accordion areas from one view to the next. Steps 1045 and 1050 may be performed in the manner described with respect to FIG. 9, for example.

The foregoing examples have been provided merely for the purpose of explanation and are in no way to be construed as limiting of the present invention. While aspects of the present invention have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although aspects of the present invention have been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method of generating an employee benefit user interface (UI), comprising:
generating a first level user interface (UI) based on a user input, wherein the first level UI simultaneously displays information of plural different insurance plans in respective areas associated with the plural different insurance plans;
receiving a user input of a selected topic at an area of the first level UI outside the respective areas; and
reconfiguring the first level UI to display, in the respective areas, information regarding the selected topic for each of the plural different insurance plans.

2. The method of claim 1, wherein the user input of the selected topic is a user selection of the selected topic at a list of topics in the first level UI.

3. The method of claim 1, wherein the generating the first level UI comprises:
accessing stored information associated with each one of the plural different insurance plans; and
formatting the accessed information for display in predefined areas of the first level UI.

4. The method of claim 1, further comprising:
determining a respective estimated cost for each of the plural different insurance plans; and
simultaneously displaying the respective estimated costs in the first level UI.

5. The method of claim 4, wherein the respective estimated costs are determined based on a set of covered persons.

6. The method of claim 5, further comprising:
receiving a user selection of a different set of covered persons;
determining a new respective estimated cost for each of the plural different insurance plans based on the different set of covered persons; and
reconfiguring the first level UI to simultaneously display the new respective estimated costs.

7. The method of claim 6, wherein the user selection of the different set of covered persons is a user selection from a list of persons in the first level UI.

8. The method of claim 1, further comprising:
receiving a user input to view details of a selected one of the plural different insurance plans;
generating a second level UI that includes information associated with the selected one of the plans; and
navigating to the second level UI.

9. The method of claim 8, further comprising:
receiving a user input of a selected topic in the second level UI; and
expanding or collapsing an accordion area associated with the selected topic.

10. The method of claim 9, wherein:
the accordion area of the selected topic is expandable to display additional information of the selected one of the plans; and
the additional information is associated with the selected topic.

11. The method of claim 9, further comprising:
storing additional information for plural topics for each of the plural different insurance plans; and
accessing the stored additional information based on the user input of the selected topic in the second level UI.

12. The method of claim 9, further comprising:
receiving a user input to select a different one of the plural different insurance plans in the second level UI; and
reconfiguring the second level UI to display information associated with the different one of the plans.

13. The method of claim 12, further comprising maintaining an arrangement of expanded and collapsed accordion areas when reconfiguring the second level UI.

14. A computer system for generating an employee benefit user interface (UI), comprising:
a hardware memory device that stores program instructions; and
a hardware processor that executes the program instructions and causes the computer system to:
receive an initial user input;
generate a first level user interface (UI) based on the initial user input, wherein the first level UI simultaneously displays information of plural different insurance plans;
determine a respective estimated cost for each of the plural different insurance plans based on a set of covered persons to be covered by the plural different insurance plans, wherein the displayed information includes the respective estimated costs;
receive a user selection of a different set of covered persons;
determine a new respective estimated cost for each of the plural different insurance plans based on the different set of covered persons; and
reconfigure the first level UI to simultaneously display the new respective estimated costs.

15. The computer system of claim 14, wherein the user selection of the different set of covered persons is a user selection from a list of persons in the first level UI.

16. The computer system of claim 14, further comprising:
receiving a user input to view details of a selected one of the plural different insurance plans;
generating a second level UI that includes information associated with the selected one of the plans; and
navigating to the second level UI.

17. The computer system of claim 16, further comprising:
storing additional information for plural topics for each one of the plural different insurance plans;
receiving a user input of a selected topic of the plural topics in the second level UI; and
expanding or collapsing an accordion area associated with the selected topic, wherein the accordion area displays the additional information of the selected topic of the plural topics when expanded.

18. The computer system of claim 16, further comprising:
receiving a user input to select a different one of the plural different insurance plans in the second level UI; and
reconfiguring the second level UI to display information associated with the different one of the plans while maintaining an arrangement of expanded and collapsed accordion areas.

19. A computer program product comprising computer readable program instructions stored on computer readable storage medium, the computer readable program instructions causing a computing device to:
receive an initial user input;
generate a first level user interface (UI) based on the initial user input, wherein the first level UI simultaneously displays information of plural different insurance plans;
receive a user input to view details of a selected one of the plural different insurance plans;
generate a second level UI that includes additional information associated with the selected one of the plans;
navigate to the second level UI based on the receiving the user input to view details of the selected one of the plural different insurance plans;
receive a user input to select a different one of the plural different insurance plans in the second level UI; and
reconfigure the second level UI to display additional information associated with the different one of the plans while maintaining an arrangement of expanded and collapsed accordion areas of the second level UI.

20. The computer program product of claim 19, wherein the computer readable program instructions cause the computing device to:
receive a user input of a selected topic of plural topics in the second level UI; and
expand or collapse one of the accordion areas associated with the selected topic.
